(19) United States
(12) Patent Application Publication
(10) Pub. No.: US 2014/0213199 A1
(43) Pub. Date: Jul. 31, 2014

(54) Automatic Self-Powered Antenna Switch

(71) Applicant: STARTRAK INFORMATION TECHNOLOGIES, LLC, Morris Plains, NJ (US)

(72) Inventor: Herbert Perten, Suffern, NY (US)

(73) Assignee: STARTRAK INFORMATION TECHNOLOGIES, LLC, Morris Plains, NJ (US)

(21) Appl. No.: 13/754,384

(22) Filed: Jan. 30, 2013

(51) Int. Cl. H04B 1/48

(52) U.S. Cl. CPC H04B 1/48
USPC 455/83

(57) ABSTRACT

An antenna switch is provided, comprising: an antenna cable connector that connects to a radio RF output port that both receives an RF signal at a receive frequency, and transmits an RF signal at a transmit frequency that differs from the receive frequency; an RF switch having a common contact that is switchable between a receive antenna contact and a transmit antenna contact; a level comparator comprising an input connected to the antenna cable that: when a voltage at the input is below a predefined threshold value, causes the RF switch to contact the receive antenna; and when the voltage at the input is above a predefined threshold value, causes the RF switch to contact the transmit antenna.

### BACKGROUND

Disclosed herein is an automatic self-powered antenna switch which automatically connects a common antenna feed line to an antenna receive or transmit element as appropriate.

Many radio systems utilize different frequencies for transmitting and for receiving signals. Ideally, antennas can be provided which will work efficiently over both frequency bands, allowing the use of single elements for the total system. In practice, due to various constraints, it is not always possible to design such antennas. This requires the use of separate antenna elements for transmitting and for receiving. Additional system complexity and cost is incurred by the need for multiple feed lines or separate control lines to operate antenna switches.

The simplest way of connecting to multiple antenna elements is with multiple feed lines. In one implementation currently in use, the radio transmitter connects to its dedicated antenna through one coaxial cable and the radio receiver connects to its dedicated antenna through a different coaxial cable. This requires that the radio be designed with separate RF connections for the receiver and the transmitter, plus one must incur the additional cost of two lengths of coaxial cable and their associated connectors and supports.

FIG. 1 schematically shows an alternative that include an RF antenna relay RFSW1 in the antenna housing. This allows the use of radios with single RF connections and single lengths of coaxial cable. In one implementation currently in use, a separate cable CC1, containing one or more conductors, is used to control the antenna relay RFSW1.

An antenna assembly AA1 contains discrete receive RA1 and transmit TA1 elements. Either may be connected to the antenna cable AC1 and radio RAD1 through appropriate contacts in the RF switch RFSW1. This switch RFSW1 is controlled by a control CONT1. Quiescently, the switch RFSW1 causes the radio RAD1 to be connected to receive antenna RA1, because this is usually the dominant mode of operation. At such time as it is desired to initiate a transmission, the controller CONT1 first generates a signal to cause the switch RFSW1 to move to its normally open NO set of contacts, connecting the transmit antenna TA1 to the radio RAD1. The control CONT1 then instructs the radio RAD1 that it may transmit. At the conclusion of the transmission, the radio RAD1 informs the control CONT1 of this status and the control CONT1 removes the actuating signal from the switch RFSW1, causing the switch RFSW1 to return to its normally closed NC contacts, again connecting the receive antenna RA1 to the radio RAD1. The ground return is best effected through a second conductor within CC1, but may also use the shield of the antenna cable AC1. The ground return is omitted from the figure for clarity.

When the antenna assembly AA1 is distant from the radio RAD1, the cost of the control cable CC1 can be significant.

FIG. 2 shows an alternative currently in use that uses the RF coaxial cable for powering the antenna as well. This is commonly called “phantom powering”.

Here again, the antenna assembly AA2 is made up of receive RA1 and transmit TA1 antenna elements. They are connected to contacts of the RF switch RFSW1 like in FIG. 1. However, in this implementation, there is no need for a separate control cable CC1. Power to operate the antenna switch RFSW1 is passed along the same physical antenna cable AC2 as the RF signal.

First and second capacitors C1 and C2 are sized to be of insignificant impedance at the frequencies of interest; first and second inductors L1 and L2 are sized to be of effectively infinite impedance at the frequencies of interest. Thus, the RF path through the first capacitor C1, the antenna cable AC2, and the second capacitor C2, and the DC power path through the first inductor L1, the antenna cable AC2, and the second inductor L2 can coexist within the same physical antenna cable AC2 without interfering with each other. The ground return, through the shield of the antenna cable AC2 is not shown for clarity.

Although this solves the problem of multiple cables going from the radio to the antennas, it still requires circuitry added at both ends of the cable, plus an explicit control signal to determine when to switch the antenna relay to the transmit or receive element.

FIG. 3 is a circuit diagram that illustrates a design that can be used when the receive and transmit frequencies are sufficiently far apart. In this design, it is possible to insert a frequency selective network which electrically connects the single coaxial cable to the appropriate antenna depending on the frequency of signals it is carrying.

Here the two antenna elements RA1 and TA1 are as in the previous figures. The radio RAD1 is as before. However, there is no need for a separate controller or control signal. Instead of an RF switch, this implementation introduces a frequency dependent splitter FS1, which may contain passive or active components or both. Depending on the frequency present, it will steer the RF energy accordingly. For instance if the transmit frequency is above the receive frequency, a high-pass filter might connect the antenna cable AC2 to the transmit antenna TA1 and a low-pass filter might connect the antenna cable AC2 to the receive antenna RA1.

However, there are many cases where the two frequencies are not far enough apart to allow realization of a frequency selectable element as shown here. These configurations require an antenna relay as described above (FIGS. 1 and 2). In addition, the frequency splitter requires low loss components on the high power (transmit) side, which may be difficult and/or expensive to implement.

### SUMMARY

Accordingly, an antenna switch is provided, comprising: an antenna cable connector that connects to a radio RF output port that both receives an RF signal at a receive frequency, and transmits an RF signal at a transmit frequency that differs from the receive frequency; an RF switch having a common contact that is switchable between a receive antenna contact and a transmit antenna contact; a level comparator comprising an input connected to the antenna cable that: when a voltage at the input is below a predefined threshold value, causes the RF switch to contact the receive antenna; and when the voltage at the input is above a predefined threshold value, causes the RF switch to contact the transmit antenna.

### DESCRIPTION OF THE DRAWINGS

Various embodiments of the invention are illustrated in the drawings and detailed description below:

FIG. 1 is a schematic diagram illustrating a known design for connecting a radio to transmit and receive antennas using a switch controlled by a control;

FIG. 2 is a schematic diagram illustrating a known design similar to that of FIG. 1, but using the RF coaxial cable for powering the antenna as well;

FIG. 3 is a schematic diagram illustrating a known design that can be used when the receive and transmit frequencies are sufficiently far apart;

FIG. 4 is a schematic diagram illustrating an embodiment of the inventive design for connecting a radio to transmit and receive antennas using a switch controlled by a control; and

FIG. 5 is a schematic diagram illustrating an embodiment for powering the active devices.

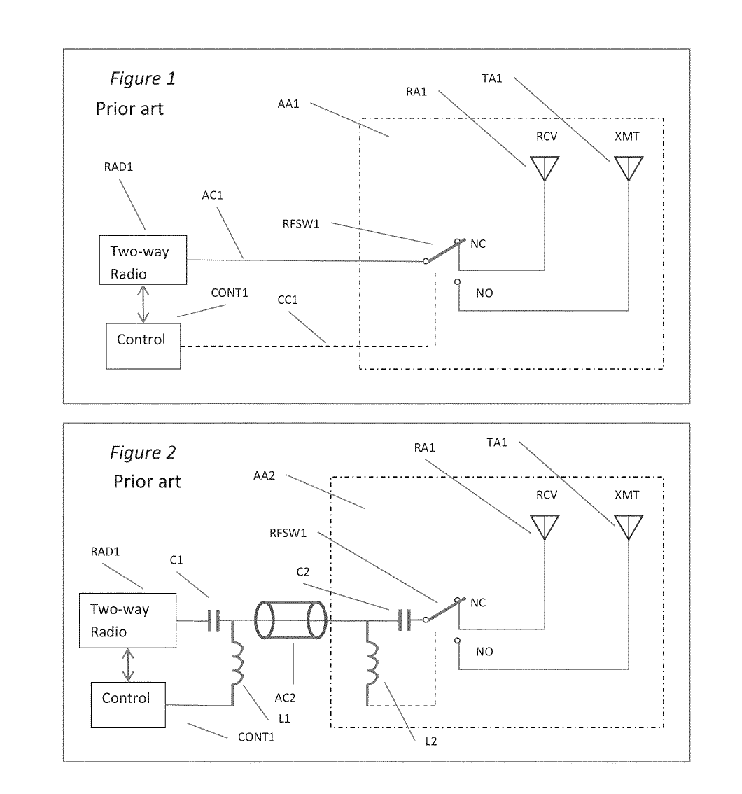

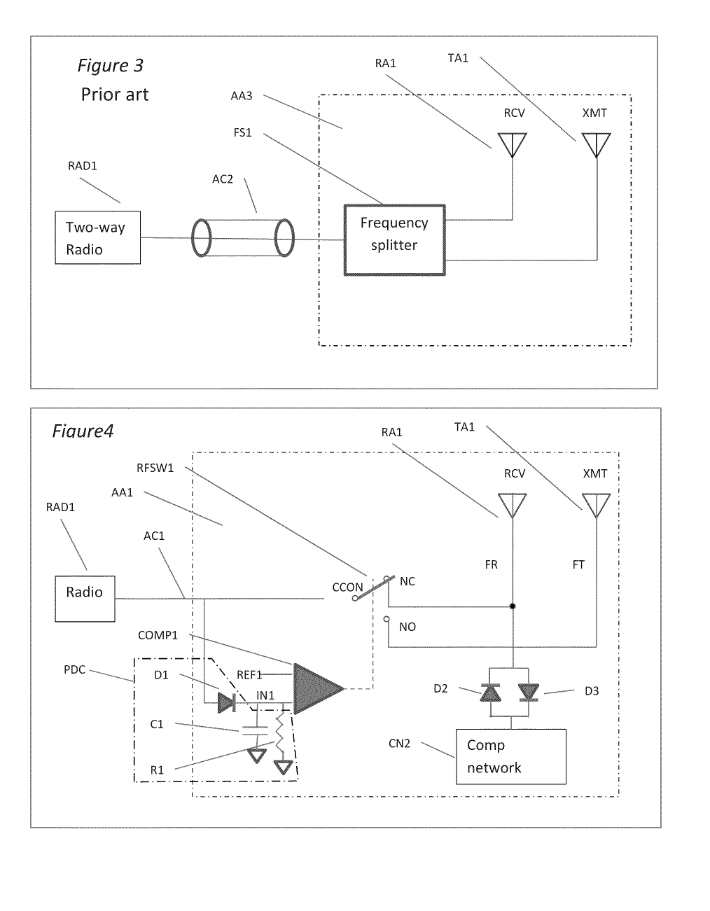

### DETAILED DESCRIPTION

An automatic antenna switch as described in the following paragraphs may be used for those applications where: 1) the transmit power is significantly higher than the receive power; and 2) the baud rate is slow as compared to the switch speed.

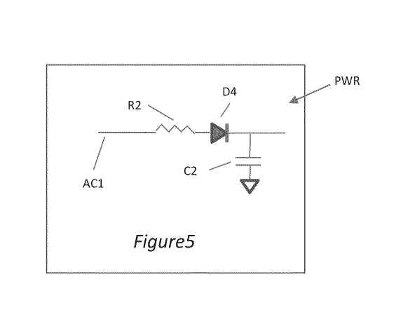

Referring to FIG. 4, the radio contains a single RF output port which internally connects to both the receiver and the transmitter. In one implementation using a system of low earth satellite repeaters, the transmitter output is 5 W into 50 ohms (37 dBm), while the receive signal strength may be as much as −80 dBm. The first condition stated above (transmit power much greater than received power) is met by this system. Converting from dBm to peak sinusoidal voltage, when transmitting, there is 22.3 v peak on the transmission line, while when receiving there is 31.6 μv peak on the line. A level comparator COMP1 is used to sense this difference and moves the antenna switch RFSW1 when the signal is large (i.e., transmitter is active).A diode D1 and capacitor C1 form a peak detection circuit PDC which charges the capacitor C1 to a diode drop voltage below the peak voltage of the transmission. A resistor R1 allows for a deterministic decay of the voltage so the system switches to a receive mode a predetermined time after the transmission has ended.

For the first several hundreds of nanoseconds, before the antenna switch RFSW1 has connected the transmitting antenna TA1 element to the transmission line AC1, the receive antenna RA1 will still be connected. Because this receive antenna RA1 is not tuned to the transmitter frequency FT, it will present an impedance mismatch to the transmission line AC1, potentially damaging the transmitter or generating spurious radiations. To counter this, an optional matching network CN2 is included.

Working in conjunction with the receive antenna RA1, this presents an impedance match close to, e.g., 50 ohms for the transmission line AC1. This is separated from the transmission line AC1 by a pair of diodes D2 and D3, which appear as open circuits to signals as small as the receive signals, but conduct for signals as large as the transmission signals. Thus, a matching network is implemented which only is connected for signals above a diode drop in magnitude 0.6 v. Therefore, the bulk of the transmission signal will see a proper match before the antenna switch RFSW1 connects the proper transmission antenna TA1. The receive signal, having a voltage so much smaller than the voltage necessary to bring a diode into conduction, will not be affected by this matching network CN2.

A switch that might be used in this implementation is RFSW8000 from RF Micro Devices, Inc., the specification sheet being incorporated herein by reference. In the system according to the embodiment described above, an uplink data communications baud rate is 2400 baud (416 μsec/bit). The switch changes state in 100-300 nsec, far faster than the bit rate, so the second condition stated above is met (this is true for bit rates over 3.3 Mbaud, with a 300 nsec switch, and three times that for a 100 nsec switch).The small fraction of the first portion of the transmission signal which is used to charge up C1 is insignificant as compared to the full bit width and does not interfere with the decoding of the data.

Switches such as the RFSW8000 require a pair of drive signals in quadrature, i.e., one must be at a high voltage and other at a low voltage for the switch to be in one state, and the converse must be true to move the switch to the other state. This may be implemented with a pair of CMOS logic inverters, such as CD4049, available from Texas Instruments and others.

Several ways are proposed for powering active devices that are associated with the switch (including the switch itself and/or logic components, such as the inverter stage noted with respect to the CD4049 device, or other components). The first of these is to include a small primary battery in the antenna housing. The switch RFSW1 described above RFSW8000requires a bias current of 5 μa, so a small lithium battery will last for several years, and provisions should be made to replace this battery before it has run down. The RF switch RFSW1 may be designed to be quiescently connected to the receive antenna, so the system is ready at all times to receive signals.

A second way of powering the active devices is shown in the second power option PWR of FIG. 5. Here a fraction of the transmission power is used to energize the switching system. A rectifier and filter network, made from a fourth diode D4 and second capacitor C2 gleans a DC charge from the transmission waveform, storing enough energy on the large value capacitor C2 to bias the system until the next transmission occurs to charge it up again.

In one implementation, the system is configured to transmit at least once per day, which also serves to re-charge the capacitor. A second resistor R2 may be inserted to lessen the peak load on the transmission signal when the capacitor C2 voltage is well below peak and would appear as a temporary short circuit across the transmission signal. With properly sized components, the loss to the leading edge of the transmission signal will be negligible.

Note that the battery powered system described does not require any transmissions to properly bias the antenna relay, while the self-powered system PWR does. If transmissions do not occur in time to recharge the capacitor C2 to a necessary level to power the system, the RF switch RFSW1 may move to a state wherein the neither antenna element RA1, TA1 is connected. It will resume proper operation directly after a transmission occurs.

The power supply can utilize any form of active or self-powered implementation or power storage mechanisms. For example, the following could be used in the power supply: solar power, wind-based power, water-based power, chemical reaction devices, such as various types of batteries and fuel cells, and the like.

All references, including publications, patent applications, and patents, cited herein are hereby incorporated by reference to the same extent as if each reference were individually and specifically indicated as incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The embodiments may be described in terms of functional block components and various processing steps. Such functional blocks may be realized by any number of components that perform the specified functions.

The particular implementations shown and described herein are illustrative examples of the invention and are not intended to otherwise limit the scope of the invention in any way. For the sake of brevity, conventional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Expressions such as “at least one of,” when preceding a list of elements, modify the entire list of elements and do not modify the individual elements of the list.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

The words “mechanism” and “element” are used herein generally and are not limited solely to mechanical embodiments. Numerous modifications and adaptations will be readily apparent to those skilled in this art without departing from the spirit and scope of the invention.

### TABLE OF REFERENCE CHARACTERS

AA1, antenna assembly
AA2
AC1, antenna cable
AC2
C1, C2 first and second capacitors
CC1 control cable
CCON common contact
CN2 optional matching network
COMP1 level comparator
CONT1 control block
D1, D2, first through fourth diodes
D3, D4
FR receive frequency
FS1 frequency splitter
FT transmit frequency
IN1 comparator input
L1, L2 first and second inductors
PDC peak detection circuit
PWR second power option
R1, R2 first and second resistors
RA1 receive element
RAD1 radio
REF1 comparator reference
RFSW1 RF switch
TA1 transmit element

What is claimed is:

1. An antenna switch comprising:
an antenna cable connector that connects to a radio RF output port that both receives an RF signal at a receive frequency, and transmits an RF signal at a transmit frequency that differs from the receive frequency;
an RF switch having a common contact that is switchable between a receive antenna contact and a transmit antenna contact;
a level comparator comprising an input connected to the antenna cable that:
when a voltage at the input is below a predefined threshold value, causes the RF switch to contact the receive antenna; and
when the voltage at the input is above a predefined threshold value, causes the RF switch to contact the transmit antenna.

2. The antenna switch according to claim 1, wherein the level comparator comprises a peak detection circuit at the input that detects a peak voltage value at the input.

3. The antenna switch according to claim 2, wherein the peak detection circuit comprises:
a diode comprising an input connected to the antenna cable, and an output connected to the input; and
a capacitor and a resistor connected in parallel between the input and ground.

4. The antenna switch according to claim 1, further comprising:
a matching network that provides an output impedance, when combined with the receive antenna, when driven at the transmit frequency, that is equal to an output impedance of the transmit antenna alone when driven at the transmit frequency.

5. The antenna switch according to claim 4, further comprising circuitry that allows a voltage magnitude equal to or exceeding a predefined matching network threshold value to enter the matching network, and that blocks a voltage magnitude less than the predefined matching network threshold value from entering the matching network.

6. The antenna switch according to claim 5, wherein the circuitry comprises a pair of diodes connected in parallel, but with reverse polarity from one another, between the matching network and the receive antenna.

7. The antenna switch according to claim 1, further comprising a power supply connected to active components associated with the switch to power these active components.

8. The antenna switch according to claim 7, wherein the power supply comprises an active power source.

9. The antenna switch according to claim 8, wherein the active power source is at least one of a, a solar power device, a wind power device, a water-power device, and a chemical-based device, including a battery.

10. The antenna switch according to claim 7, wherein the power supply is a passive device that stores energy.

11. The antenna switch according to claim 7, wherein the power supply stores a small portion of transmit energy.

12. The antenna switch according to claim 11, wherein the power supply PWR comprises a resistor R2 connected in series with a diode D4, and a capacitor C2 is connected between ground and a terminal of the diode D4 opposite the resistor R2.

13. The antenna switch according to claim 7, wherein the active components include an inverter stage.

14. The antenna switch according to claim 1, wherein the switch can change state faster than maximum transmitted bit rate.

15. The antenna switch according to claim 14, wherein the switch state is changeable in less than 300 nsec.

16. The antenna switch according to claim 14, wherein the maximum bit rate is 2400 baud.
